(19) United States
(12) Patent Application Publication
(10) Pub. No.: US 2012/0109843 A1
(43) Pub. Date: May 3, 2012

(54) Visual analysis of a time sequence of events using a time density track

(76) Inventors: Ming C. Hao, Palo Alto, CA (US); Christian Rohrdantz, Konstanz (DE); Umeshwar Dayal, Saratoga, CA (US); Daniel Keim, Steisslingen (DE); Lars-Erik Haug, Gilroy, CA (US)

(21) Appl. No.: 12/925,684

(22) Filed: Oct. 27, 2010

(51) Int. Cl. G06F 3/048; G06Q 10/00

(52) U.S. Cl. 705/347; 715/772

(57) ABSTRACT

Data records representing a time sequence of events are received, where time gaps between successive events vary. A first visualization having a sequence of graphical elements representing the corresponding events is generated, where the graphical elements do not overlay each other. A second visualization includes a time density track having gap representing elements, where the gap representing elements have different characteristics to represent different gaps between respective successive events.

### BACKGROUND

An enterprise, such as a company, educational organization, government agency, and so forth, can receive a large amount of feedback from users or customers in the form of comments received over time. If there is a large volume of comments, then it can be relatively difficult for analysts to manually detect problems indicated by the customer feedback.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

Some embodiments are described with respect to the following figures:

FIG. 1 is a flow diagram of a process of visual analysis according to some implementations;

FIG. 2 illustrates an example visual analysis technique that uses a comment sequence track and a time density track, according to some implementations;

FIG. 3 illustrates in greater detail a portion of the comment sequence track and a time density track produced from records representing a time sequence of events, according to some implementations;

FIG. 4 is a flow diagram of generating visualizations according to some implementations;

FIGS. 5 and 6 illustrate other examples of performing visual analysis using comment sequence tracks and time density tracks, according to some implementations; and

FIG. 7 is a block diagram of an example system incorporating a visual analysis mechanism according to some implementations.

### DETAILED DESCRIPTION

An enterprise can receive relatively large amounts of data, such as customer feedback in the form of comments. The comments can be received over a network, such as the Internet, where customers can supply comments regarding a product or service through the enterprise's website or through a third party website such as a social networking site. Alternatively, or additionally, comments can be received in paper form and entered by the enterprise's personnel into a system in electronic form.

Data records can be stored to represent the time sequence of comments. In some cases, it may be desirable to visually analyze the comments by employing automated visualization of the comments in graphical form (without a user having to read the individual comments). When there is a relatively large number of comments, however, graphical elements representing corresponding comments can be close to each other or can actually overlap each other, particularly when the comments are associated with the same time points or time points that are relatively close to each other. A large number of overlapping graphical elements or graphical elements close to each other can make it difficult to understand what is being represented by the graphical elements.

In the ensuing discussion, reference is made to visually analyzing customer comments. Note, however, that techniques according to some implementations can also be applied to data records representing other types of events, such as measurements taken by sensors within a system (e.g., a network of computing devices), or other types of events.

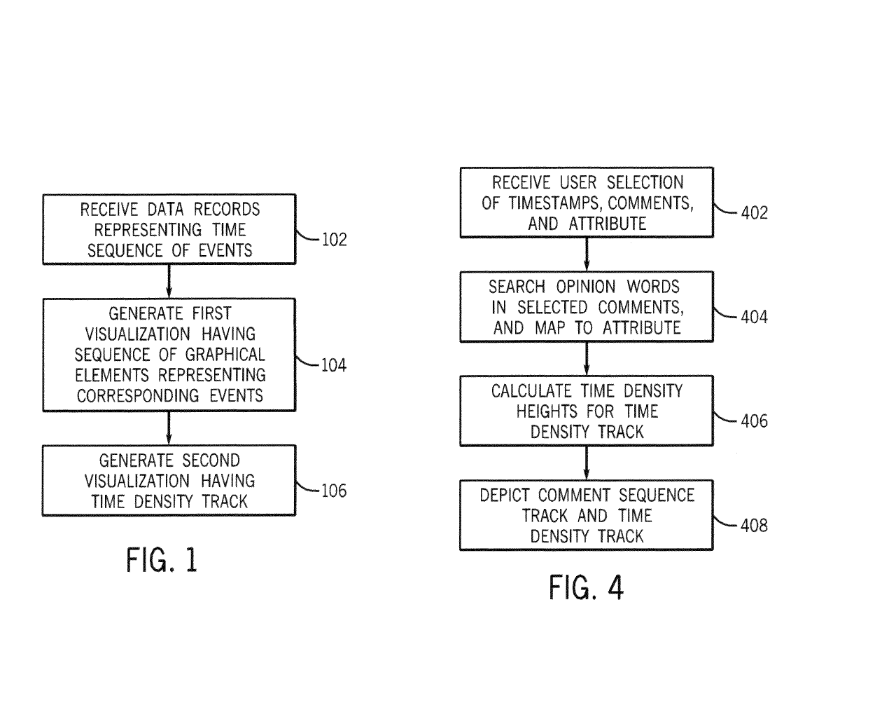

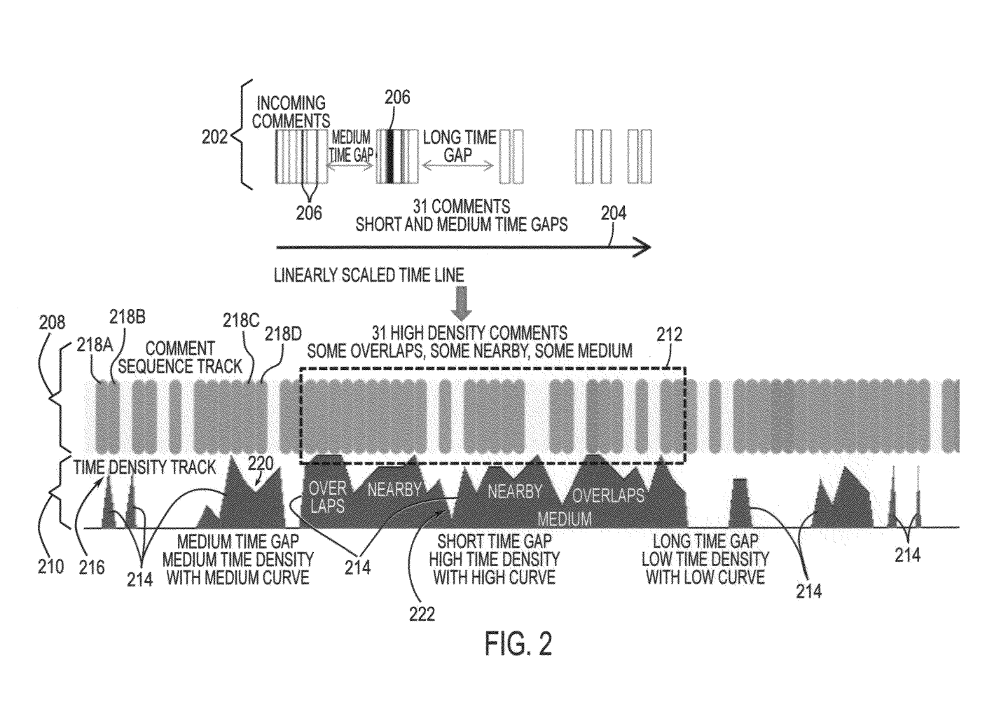

Referring to FIGS. 1 and 2, techniques according to some implementations are for performing visual analysis of a time sequence of events are depicted. A system receives (at 102) data records representing a time sequence of events, where time gaps between successive events vary. An example time sequence of events is depicted as sequence 202 in FIG. 2. In FIG. 2, the horizontal axis 204 represents a timeline. The data records in the sequence 202 represent incoming customer comments. Each rectangle in FIG. 2 represents a corresponding customer comment. The timeline 204 is a linearly scaled timeline (in other words, any two gaps between any pair of customer comments along the timeline 204 of the same length represent the same time interval). The rectangles are arranged in temporal order corresponding to time points associated with an arrival sequence of the corresponding comments (where “arrival sequence” refers to the sequence in which the comments are received by the system).

In dense regions of the sequence 202 (regions that have relatively large numbers of comments close in time to each other or having the same time), the rectangles can overlap either partially or even entirely (such as when there are multiple comments associated with the same time point). The time point with which a comment (or other type of event) is associated with can represent the time point at which the comment (or other event) was created, received, submitted, and so forth. Any gap between two rectangles in the sequence 202 represents a time gap between the respective comments. Darker lines or even dark rectangles (206) in the sequence 202 represents multiple comments that are close in time to each other (note that the rectangles of the corresponding comments overlap each other).

To address the issue of overlapping graphical elements (e.g., overlapping rectangles in the sequence 202 of FIG. 2), two different visualizations are generated in accordance with some implementations. The system generates (at 104) a first visualization (in the form of a comment sequence track 208). The comment sequence track 208 has a sequence of graphical elements (in the form of general ovals or rectangles with curved ends) each representing a corresponding comment. The graphical elements in the comment sequence track 208 are arranged such that they do not overlap each other (unlike the rectangles in the sequence 202 along the linearly scaled timeline 204).

In the example of FIG. 2, 31 comments represented by the sequence 202 are provided in a dashed box 212 enclosing 31 respective graphical elements of the comment sequence track 208. The graphical elements in the comment sequence track 208 are arranged in sequential temporal order (based on the time point associated with the respective comments). The exact time points associated with the comments are not relevant to the comment sequence track 208. The comment sequence track 208 maintains the temporal order, but removes space-consuming gaps (such as those shown in the sequence 202) and removes overlapping of graphical elements representing respective comments. Thus, in the comment sequence track 208, the horizontal axis does not convey exact temporal relations; instead, the same amount of space (equal space) is provided to each graphical element in the comment sequence track 208 such that a user can clearly see the arrival sequence of the graphical elements (note that none of the graphical elements in the comment sequence track 208 is occluded by another of the graphical elements).

The graphical elements in the comment sequence track 208 are assigned different colors corresponding to different values of a respective attribute of the respective comment. In the example of FIG. 2, the colors that can be assigned to each of the graphical elements of the comment sequence track 208 includes grey, green, and red. In some examples, the attribute being represented by the color can be a topic keyword that can be found in the comments received. For example, comments can be received regarding a website of an enterprise, regarding usage of passwords, and so forth. The grey color assigned to the attribute indicates that the feedback received is neutral (not negative and not positive). The green color indicates positive feedback (e.g., a customer is satisfied with the attribute). On the other hand, red represents a negative feedback (e.g., the customer is not satisfied with the attribute). In the example of FIG. 2, some graphical elements have a lighter shade of red, while other graphical elements have a brighter shade of red. The different shades of red can indicate different levels of customer dissatisfaction.

Other examples of attributes that can be represented by different colors of the graphical elements in the comment sequence track 208 include product features, concepts, persons, etc.

Since the inter-event temporal information (in other words, time gaps between comments) has been removed in the comment sequence track 208, a second visualization is generated (at 106), which can be in the form of a time density track 210. The time density track 210 has gap representing elements to represent time gaps between respective successive comments. In the example of FIG. 2, the gap representing elements of the time density track 210 includes points along a curve 214. The height of a point along the curve 214 represents the time gap between two successive comments represented by two successive graphical elements of the comment sequence track 208. The gap representing elements of the time density track 210 are aligned with the graphical elements of the comment sequence track 208 to allow for easy correlation between the time density track 210 and the comment sequence track 208.

For example, a point 216 that has a high value indicates that the comments represented by respective graphical elements 218A and 218B in the comment sequence track 208 are relatively close to each other in time (and in fact, overlap each other). Another point 220 that has an above average height indicates that two successive comments represented by graphical elements 218C and 218D in the comment sequence track 208 are relatively close to each other (they do not overlap but have a relatively short time gap in between).

Another point 222 having a below average height indicates that the two corresponding comments represented by two respective graphical elements in the comment sequence track 208 have a medium gap between each other. A zero height of a point along the curve 214 indicates that there is a relatively long time gap between successive events.

By looking at the curve 214 of the time density track 210, an analyst can quickly identify points along the comment sequence track that would be more interesting (for example, points along the comment sequence track 208 associated with negative feedback and where the comments are arriving relatively close in time to each other). Such an “interesting” point along the comment sequence track 208 can correspond to times when some problem has occurred, such as a website crashing, a product being out of stock, and so forth. Since the graphical elements of the comment sequence track 208 do not occlude each other, a user can go to any point along the comment sequence track 210 and select, using an input device, respective ones of the graphical elements to obtain further detail regarding the respective comments. Also, by looking at the combination of the comment sequence track 208 and time density track 210, patterns can become more visible to the analyst. The pattern can be based on colors of the graphical elements of the common sequence track 208, along with the varying heights of the curve 214 in the time density track 210.

The visualizations in FIG. 2 are able to accept interactive user input. For example, in regions of interest, a user can use an input device to select or move a cursor over a graphical element of interest, to see further details regarding the corresponding customer comment, such as to view the entire comment or to see a summary of the comment. In this manner, the user can interactively select further details regarding comments at the individual comment level.

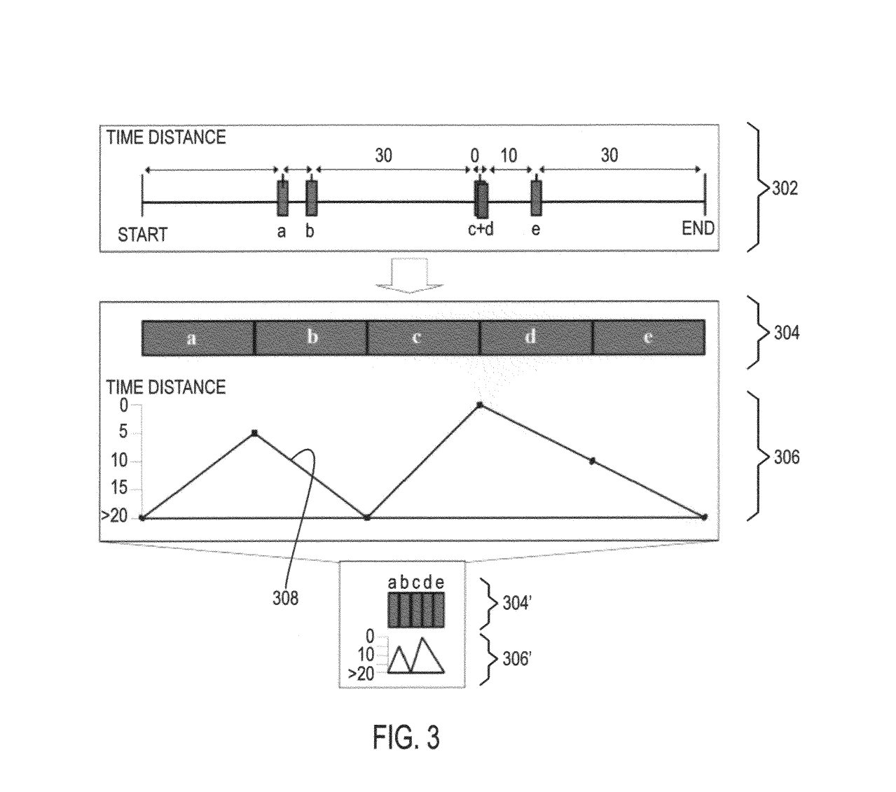

FIG. 3 illustrates the comment sequence track and time density track in the context of an example with fewer incoming comments. In the example of FIG. 3, an input sequence 302 of comments is represented by rectangles along a timeline represented by the horizontal axis. Specific time gaps are provided between successive comments. For example, the time gap between comments a and b is 5 time units (e.g., 5 minutes, 5 hours, etc.). The time gap between comments b and c is 30 time units, the time gap between comments c and d is 0, and the time gap between comments d and e is 10 time units. In view of the overlapping of comments c and d (which in fact may be associated with the same time point), the respective rectangles representing the corresponding comments overlap each other. In the example of FIG. 3, the five comments (a-e) are present in an overall time interval of 100 time units.

To remove time gaps between comments and to avoid representing overlapping comments with overlapping graphical elements, a comment sequence track 304 is generated having five graphical elements (each of the same length) to represent the respective comments a-e. A time density track 306 is also generated, which can be in the form of a curve 308 having points (small squares) to represent respective time gaps between successive pairs of comments. For example, the point on the curve 308 corresponding to the time gap between comments a and b has a height of 5 time units (to represent the time gap of 5 time units between comments a and b). Any time gap between successive comments of greater than 20 time units (or other predefined threshold) has a zero height on the curve 308 (to indicate that the successive comments are far away from each other in time such that they are not considered to be interesting). The threshold at which the height of the curve 308 representing a time gap between comments is set at zero can be defined differently for different implementations.

In some examples, the height point (square box in the curve 308 of the time density track 306) is calculated according to:

$$time\_density \_height ( i , j ) = max [ 0 , ( 1 - \frac{timedist ( i , j )}{avgtimedist} ) ] , \qquad ( Eq . 1 )$$

where time_density_height(i, j) represents the height of the point along the curve 308 to represent the relative time gap between comments i and j, timedist(i, j) represents the time distance between comments i, j, and avgtimedist represents the average time gap between successive pairs of comments. The parameter avgtimedist is a moving average, since avgtimedist changes as more comments are received.

More generally, the height can be based on a ratio between the time gap between successive comments i and j, and the average time gap (e.g., moving average time gap) of comments received so far.

As further shown in FIG. 3, the comment sequence track 304 and time density track 306 can be reduced in width such that the graphical elements of the modified comment sequence track 304′ has the same width as the original rectangles in the incoming comment sequence 302. The modified time density track 306′ is based on the original time density track 306, but with the width reduced to correspond to the comment sequence track 304′.

FIG. 4 is a flow diagram of the process according to further implementations. User selection can be received (at 402) regarding timestamps, comments, and an attribute. For example, the user can be presented with a table having multiple columns corresponding to different information associated with incoming comments, with one of the column containing timestamps, and another of the column containing comments, and so forth. The user can select the timestamp column and the comment column on which processing according to some implementations is to be performed. The user can also select an attribute of interest (e.g., website, password, etc.).

The system can then search (at 404) opinion words in the selected comments, and map the opinion words to the selected attribute. The “opinion words” refer to words in the selected comments that have some bearing to the selected attribute. Opinion words can be considered to be relevant to the selected attribute based on proximity of the opinion words to the selected attribute The opinion words may include negative opinion words, positive opinion words, or neutral opinion words. Based on the mapped opinion words to the selected attribute, each comment can be assigned a particular color to represent whether the comment is associated with negative, positive, or neutral feedback with respect to the selected attribute. Alternatively, instead of performing searching of opinion words to map to the selected attribute, a comment may also or alternatively include a user rating (e.g. 1-5) regarding a particular attribute. Such ratings can be used for assigning colors to the graphical elements of the comment sequence track.

Next, the system calculates (at 406) time density heights for the time density track. For example, the heights of points along a curve (e.g., 214 or 308 in FIG. 2 or 3, respectively) of the time density track are calculated to represent inter-comment time gaps.

The comment sequence track and time density track are then depicted (at 408) in respective visualizations (such as shown in FIGS. 2 and 3). The colors assigned to graphical elements in the comment sequence track can be based on a mapped opinion words (identified in task 404), or alternatively, based on customer ratings of the comments. The time density track includes the time density curve having heights calculated according to task 406.

FIG. 5 illustrates a different example of a comment sequence track 502 and associated time density track 504. The comment sequence track 502 has graphical elements with colors assigned based on the attribute “password”. An example comment is depicted as 506 in FIG. 5, where the example comment indicates that the customer had a problem with the customer's password. In the example of FIG. 5, the vast majority of “password” related comments are assigned the color, which indicates that the comments are negative. Also, during a time period represented in the dashed box of FIG. 5, there was a relatively high density of “password” related comments, which can indicate that there was an underlying cause that existed during that time period.

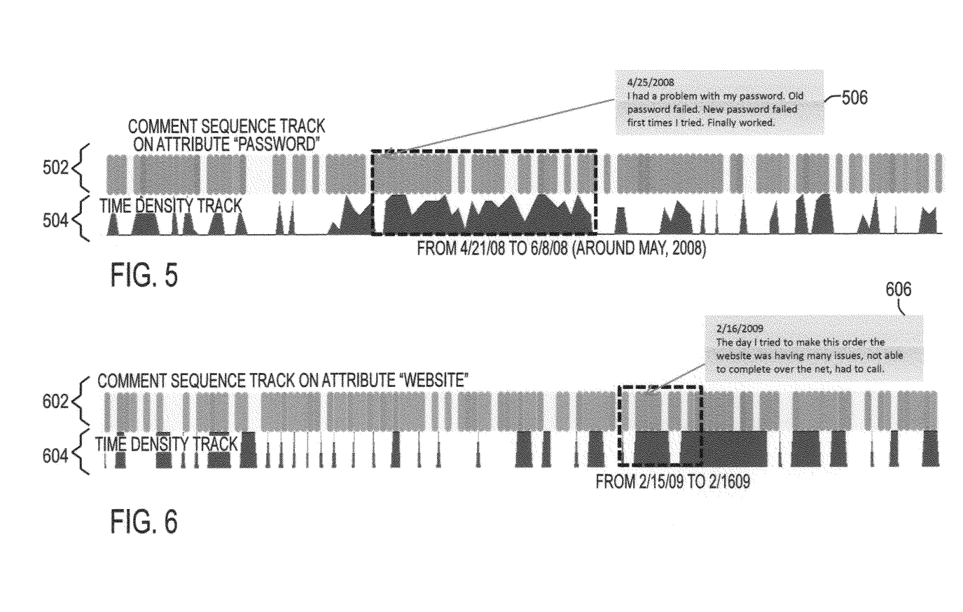

FIG. 6 shows another example that includes a comment sequence track 602 and a time density track 604. The comment sequence track 602 has graphical elements assigned colors based upon customer feedback regarding the attribute “website”. An example comment is represented as 606, which indicates that the customer tried to place an order on the website and was not able to complete the order. In the dashed box, there is a period during containing negative “website” related comments, which can be due to a holiday sale during that time, for example.

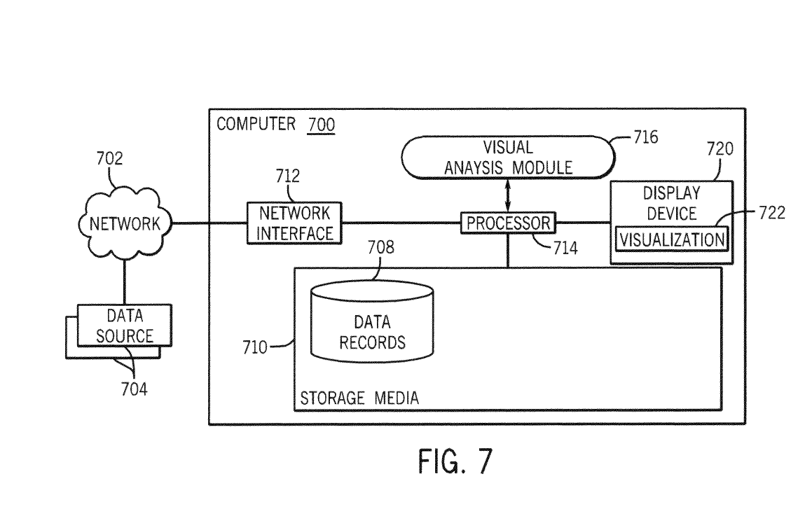

FIG. 7 is a block diagram of an example system that includes a computer 700 coupled over a network 702 to various data sources 704. The data sources 704 collect data records that are entered into the computer 700. The visualization of data records received from the data sources 704 can be performed on a real-time basis. Real-time visualization of data records refers to visualizing such data records as the data records are received. In alternative implementations, instead of performing real-time visualization of data records, the data records can be first stored, such as in a database 708 in storage media 710, and such data records can be visualized at a later time.

The computer 700 has a network interface 712 to communicate over the network 702. The network interface 712 is connected to a processor (or multiple processors) 714. A visual analysis module 716 is executable on the processor(s) 714 to perform the tasks of FIG. 1 or 4 and to present various visual representations (722) as discussed above in a display device 720.

The visual analysis module 716 can include machine-readable instructions that are loaded for execution on processor(s) 714. A processor can include a microprocessor, microcontroller, processor module or subsystem, programmable integrated circuit, programmable gate array, or another control or computing device.

Data and instructions are stored in respective storage devices, which are implemented as one or more computer-readable or machine-readable storage media. The storage media include different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; optical media such as compact disks (CDs) or digital video disks (DVDs); or other types of storage devices. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components.

In the foregoing description, numerous details are set forth to provide an understanding of the subject disclosed herein. However, implementations may be practiced without some or all of these details. Other implementations may include modifications and variations from the details discussed above. It is intended that the appended claims cover such modifications and variations.

What is claimed is:

1. A method comprising:
receiving, by a system having a processor, data records representing a time sequence of events, wherein time gaps between successive events vary;
generating, by the system, a first visualization having a sequence of graphical elements representing the corresponding events, wherein the graphical elements do not overlay each other; and
generating, by the system, a second visualization comprising a time density track having gap representing elements, wherein the gap representing elements have different characteristics to represent different gaps between respective successive events.

2. The method of claim 1, wherein generating the first visualization comprises assigning colors to the graphical elements based on values associated with an attribute of the corresponding events.

3. The method of claim 2, wherein the events correspond to respective customer comments, the method further comprising calculating the values associated with the attribute based on opinion words associated with the customer comments.

4. The method of claim 2, wherein the events correspond to respective customer comments, the method further comprising determining the values associated with the attribute based on customer ratings of the attribute in the customer comments.

5. The method of claim 2, wherein the events correspond to customer comments, and wherein assigning the colors comprises assigning different colors for negative, positive, and neutral customer comments.

6. The method of claim 1, wherein the gap representing elements include points on a curve, and wherein a height of each of the corresponding points on the curve is based on a respective gap between a respective pair of successive events.

7. The method of claim 6, further comprising calculating the heights of corresponding ones of the points based on gaps between the respective successive pairs of events and based on an average gap.

8. The method of claim 1, further comprising aligning the gap representing elements with the graphical elements to depict relative gaps between successive events.

9. The method of claim 1, further comprising arranging the graphical elements in the first visualization according to a temporal order of an arrival sequence of the respective events.

10. The method of claim 1, further comprising receiving interactive user input in the first visualization to view further details regarding selected graphical elements at an individual event level.

11. An article comprising at least one computer-readable storage medium storing instructions that upon execution cause a system having a processor to:
receive data records corresponding to events at associated time points;
generate a first visualization having graphical elements representing the events, wherein the graphical elements are arranged in a temporal order of the events, and wherein each of the graphical elements is assigned a space in the first visualization to avoid occlusion of any one of the graphical elements by another of the graphical elements; and
generate a second visualization containing a time density track having gap representing elements, wherein the gap representing elements have different characteristics to represent different gaps between respective successive events.

12. The article of claim 11, wherein the space in the first visualization assigned to each of the graphical elements is an equal space.

13. The article of claim 11, wherein the gap representing elements have different heights to represent different gaps between successive events.

14. The article of claim 11, wherein the instructions upon execution cause the system to:
determine values associated with an attribute of the events; and
assign colors to the graphical elements based on the determined values.

15. The article of claim 14, wherein a first of the colors indicates a negative value, and a second of the colors indicates a positive value.

16. The article of claim 11, wherein the events include customer comments.

17. A system comprising:
a storage media to store data records representing customer comments; and
at least one processor to:
cause display of a first visualization having a comment sequence track having graphical elements representing respective ones of the customer comments, wherein characteristics of the graphical elements vary according to differences in values associated with an attribute of the customer comments; and
cause display of a second visualization having a time density track having gap representing elements to represent time gaps between successive events, wherein the gap representing elements have different characteristics to represent different time gaps.

18. The system of claim 17, wherein the characteristics of the graphical elements comprise colors of the graphical elements.

19. The system of claim 17, wherein the graphical elements in the comment sequence track are arranged in temporal order of the customer comments, and each of the graphical elements is assigned an equal space.

20. The system of claim 17, wherein the gap representing elements include points along a curve in the time density track.
